(19) United States
(12) Patent Application Publication
(10) Pub. No.: US 2025/0386147 A1
(43) Pub. Date: Dec. 18, 2025

(54) Acoustic electromagnetic actuator with opposed magnet and spring force and output device thereto

(71) Applicant: Sound Solutions International (Zhenjiang) Co., Ltd., Zhenjiang City (CN)

(72) Inventors: Christian Kronbichler, Vienna (AT); Manuel Mefleh, Vienna (AT)

(21) Appl. No.: 19/235,159

(22) Filed: Jun. 11, 2025

(30) Foreign Application Priority Data
Jun. 14, 2024 (AT) A50491/2024

(51) Int. Cl. H04R 9/02; H04R 1/02; H04R 1/10; H04R 9/04; H04R 9/06

(52) U.S. Cl. CPC H04R 9/027; H04R 1/028; H04R 1/1075; H04R 9/045; H04R 9/046; H04R 9/06; H04R 2460/13; H04R 2499/15

(57) ABSTRACT

The invention relates to an electrodynamic actuator with a coil arrangement, a magnet system and a spring arrangement, wherein the magnet system comprises an outer magnetic circuit part, which runs radially out of the coil arrangement, wherein the coil arrangement and the outer magnetic circuit part are arranged in fixed relation to each other, and wherein the magnet system comprises an inner magnetic circuit part, which is arranged radially within the coil arrangement. The spring arrangement couples the inner magnetic circuit part to the outer magnetic circuit part and allows a relative movement between the inner magnetic circuit part and the outer magnetic circuit part in an excursion direction parallel to the coil axis, wherein the magnet force and the spring force are opposed. In addition, an output device is disclosed, which comprises a sound emanating structure and an electromagnetic actuator of said kind connected thereto.

### PRIORITY

This patent application claims priority from Austrian Patent Application No. A50491/2024, filed Jun. 14, 2024, entitled, “Acoustic Electromagnetic Actuator with Opposed Magnet and Spring Force and Output Device Thereto,” the disclosure of which is incorporated herein, in its entirety, by reference.

### BACKGROUND

The invention relates to an electrodynamic actuator, which is designed to be built into an output device and to be acoustically coupled to a sound emanating structure of the output device, wherein the electrodynamic actuator comprises a coil arrangement, a magnet system and a spring arrangement. The coil arrangement comprises at least one voice coil, which has an electrical conductor in the shape of loops running around a coil axis in a loop section. The magnet system comprises an (annular) outer magnetic circuit part, which runs radially out of the coil arrangement, wherein the coil arrangement and the outer magnetic circuit part are arranged in fixed relation to each other. Moreover, the magnet system comprises an inner magnetic circuit part, which is arranged radially within the coil arrangement. The magnet system is designed to generate a magnetic field transverse to the electrical conductor in the loop section, and the spring arrangement couples the inner magnetic circuit part to the outer magnetic circuit part and allows a relative movement between the inner magnetic circuit part and the outer magnetic circuit part in an excursion direction parallel to the coil axis. The magnet system upon excitation of the outer magnetic circuit part or the coil arrangement respectively (which excitation is a movement of the outer magnetic circuit part out of its magnetic idle position) causes a magnet force acting between the inner magnetic circuit part and the outer magnetic circuit part in a magnet force direction parallel to the coil axis. Likewise, the spring arrangement upon excitation of the outer magnetic circuit part or the coil arrangement respectively causes a spring force acting between the inner magnetic circuit part and the outer magnetic circuit part in a spring force direction parallel to the coil axis. Further on, the invention relates to an output device, which comprises a sound emanating structure with a sound emanating surface and a backside opposite to the sound emanating surface and which comprises an electromagnetic actuator of the aforementioned kind connected to said backside.

An electrodynamic actuator and an output device of the above kinds are each generally known. A drawback of these known solutions generally is a comparably poor low frequency performance what is particularly true for “small” actuators and devices. That means, a resonance frequency of these devices is relatively high. To obtain lower resonance frequencies and better low frequency performance, a “soft” suspension is needed between the inner magnetic circuit part and the outer magnetic circuit part or the coil arrangement respectively. However, there is a natural border formed by mechanical constraints meaning that a suspension cannot be made of arbitrary soft and arbitrary thin materials because the suspension has also to withstand forces occurring during use of the electrodynamic actuator and the output device. For example, there are comparably high accelerations and thus forces acting between the inner magnetic circuit part and the outer magnetic circuit part during generation of sound, in particular in the high frequency region. The suspension has to withstand theses forces to keep the electrodynamic actuator from falling apart. Another loading case is the so-called “drop test” where the electrodynamic actuator or the output device falls onto the floor under standardized conditions, for example from a height of 1 m. Very high forces can act between the inner magnetic circuit part and the outer magnetic circuit when the electrodynamic actuator or the output device hits the comparably hard floor. So, in simple words, the resonance frequency is limited by the mechanical demands on the suspension between the inner magnetic circuit part and the outer magnetic circuit part needed for normal use and operation and for a satisfying lifetime of these devices.

### SUMMARY OF THE INVENTION

Thus, it is an object of the invention to overcome the above drawbacks and to provide a better electromagnetic actuator and a better output device. In particular, a solution shall be provided, which allows lowering the resonance frequency of these devices without limiting their use and lifetime.

The inventive problem is solved by an electromagnetic actuator as defined in the opening paragraph, wherein the magnet force and the spring force are opposed.

In particular, the spring force acting on the outer magnetic circuit part points to a magnetic idle position of the outer magnetic circuit part and the magnet force acting on the outer magnetic circuit part points away from the magnetic idle position, wherein the magnetic idle position is defined as the position, in which the outer magnetic circuit part is situated in relation to the inner magnetic circuit part when no current flows through the voice coil(s) of the coil arrangement (and when no external force acts on the outer magnetic circuit part).

Furthermore, the inventive problem is solved by an output device, which comprises a sound emanating structure with a sound emanating surface and a backside opposite to the sound emanating surface and which comprises an electromagnetic actuator of the aforementioned kind connected to said backside. For example, the sound emanating structure may be a plate like structure or a housing of the output device.

By the proposed measures, a total force acting between the inner magnetic circuit part and the outer magnetic circuit part, which is the magnet force (or reluctance force) plus the spring force acting between the inner magnetic circuit part and the outer magnetic circuit part, can be substantially reduced compared to prior art designs and can be influenced in a much better way. By reversing the magnet force in view of known designs, the suspension (which is formed by the spring arrangement) between the inner magnetic circuit part and the outer magnetic circuit part gets much softer without the need to weaken the spring arrangement and hence without the need of making concessions in view of usage and lifetime of the electromagnetic actuator and the output device. Instead, the spring arrangement can even be made stronger which leads to improved resistance against breakage without increasing the resonance frequency of the electromagnetic actuator and the output device, because the magnet force can compensate or even overcompensate the higher spring constant. So, in a nutshell, the proposed measures allow lowering the resonance frequency of the electromagnetic actuator and the output device without limiting use and lifetime or allow improving use and lifetime without increasing the resonance frequency. In total, the proposed solution offers more design freedom in terms of reaching a desired output power, a desired sound quality and a desired lifetime of an electromagnetic actuator and an output device.

In particular, the sound emanating structure can be embodied as a display (which in general is a plate like structure), wherein the electromagnetic actuator is connected to the backside of the display (in particular by means of a flat mounting surface of the electromagnetic actuator). If the electromagnetic transducer is connected to the backside of the display, the output device can output both audio and video data. In this embodiment, sound generally is transmitted over the air. In particular, the output device can be a mobile device like a mobile phone and so on.

In another embodiment, the sound emanating structure can be embodied as a housing, which is designed for bone conduction or to contact a head of a user wearing the output device respectively, wherein the electrodynamic actuator is built into the output device and acoustically coupled to the housing. In this embodiment, sound is transmitted via bone conduction (i.e. via the skull of the user), and the sound emanating surface is the surface, which is intended to contact the user's head. One should note in this context, that the user head does not need to contact the sound emanating surface directly vis-à-vis of the electrodynamic actuator but may contact the sound emanating surface away from the electrodynamic actuator. In particular, the output device can be a headphone or a hearing aid in this case.

Generally, one should also note that sound in the second embodiment may even be audible via air. However, the intended sound transmission in the second embodiment is sound transmission via bone conduction. Equally, in the first embodiment, sound may even be audible via bone conduction. However, the intended sound transmission in the first embodiment is sound transmission via air.

Further, it should be noted that sound can also emanate from the backside of the sound emanating structure. However, this backside usually faces an interior space of a device (e.g. a mobile phone), which the output device is built into. Hence, the sound emanating structure may be considered to have the main sound emanating surface and a secondary sound emanating surface (i.e. said backside). Sound waves emanated by the main sound emanating surface directly reach the user's ear, whereas sound waves emanated by the secondary sound emanating surface do not directly reach the user's ear, but only indirectly via reflection or excitation of other surfaces of a housing the device, which the output device is built into. This is particularly true in case of sound transmission over the air but less in case of bone conduction, where sound waves within the output device can move within interconnected parts of the output device.

“Magnetic saturation” denotes the point, beyond which the magnetic flux density in a magnetic core does not increase with an increase of the strength of the magnetic field applied to that magnetic core. Accordingly, the saturated magnetic flux density is the maximum magnetic flux density, which a magnetic core can carry. It should be noted in this context that a diagram of the magnetic flux density over the magnetic field applied to the magnetic core does not necessarily have a (completely) horizontal section beyond the saturated magnetic flux density. Instead the given curve may also have a slope, which however is drastically lower than the curve's slope below the saturated magnetic flux density. The border formed by the saturated magnetic flux density commonly is characterized by a comparably sharp but usually rounded bend in the curve of the magnetic flux density over the magnetic field.

The term “arranged in fixed relation to each other” particularly covers embodiments, where the coil arrangement is directly mounted to the outer magnetic circuit part, and also embodiments, where intermediate parts (e.g. a frame or the like) are arranged between the coil arrangement and the outer magnetic circuit part. However, in both cases there is no relative movement between the coil arrangement and the outer magnetic circuit part.

Generally, the inner magnetic circuit part or the outer magnetic circuit part can be arranged in fixed relation to the sound emanating structure and can be mounted to a backside of the sound emanating structure directly or by use of intermediate parts. If the inner magnetic circuit part is arranged in fixed relation to the sound emanating structure, the inner magnetic circuit part can be seen as a fixed magnetic circuit part and the outer magnetic circuit part can be seen as a movable magnetic circuit part. Conversely, If the outer magnetic circuit part is arranged in fixed relation to the sound emanating structure, the outer magnetic circuit part can be seen as a fixed magnetic circuit part and the inner magnetic circuit part can be seen as a movable magnetic circuit part. Sound is generated in particular by the inertia of the movable magnetic circuit part and in more detail by the (total) force acting between the inner magnetic circuit part and the outer magnetic circuit part when a relative movement between the same is initiated.

To obtain a long life connection between the electromagnetic actuator and the sound emanating structure, the electromagnetic actuator can comprise a flat mounting surface, which is intended to be connected to the backside of the sound emanating structure, wherein said backside is oriented perpendicularly to the coil axis.

It should also be noted that a conductor of the voice coil is not limited to a particular shape, but can have a circular cross section as well as flat conductive structures like metal foils, which are interconnected to form a voice coil or a coil arrangement. The coil arrangement particularly can comprise exactly two axially spaced voice coils, each having an electrical conductor in the shape of loops running around a coil axis in a loop section.

Moreover, one should note that the term “magnetic circuit part” does not imply that this part indeed comprises or consists of a magnet. Instead, this part can comprise or can consist of a ferro-magnetic material (e.g. soft iron) without generating a magnetic field. However, to generate a magnetic field, a magnet is arranged either in the inner magnetic circuit part or in the outer magnetic circuit part or in both.

The magnetic force, the spring force and the total force may have a linear, a progressive or a degressive course over the excursion of the outer magnetic circuit part, for example. The characteristics may also be mixed to obtain a desired course of the total force. For example, a progressive magnetic force can be combined with a degressive spring force or vice versa, or a progressive magnetic force can be combined with a linear spring force or vice versa.

One should generally note that the magnet force and the spring force acting on the outer magnetic circuit part cause corresponding counter forces acting on the inner magnetic circuit part. Basically, the force directions for the inner magnetic circuit part are opposite to those for the outer magnetic circuit part. So, whenever reference is made to forces acting on the outer magnetic circuit part, also forces acting on the inner magnetic circuit part are meant equivalently.

Similarly, one should generally note that the magnetic idle position of the outer magnetic circuit part strictly speaking is a relative magnetic idle position between the inner magnetic circuit part and the outer magnetic circuit part. So, whenever reference is made to the idle position of the outer magnetic circuit part, also the idle position of the inner magnetic circuit part and the relative magnetic idle position between the inner magnetic circuit part and the outer magnetic circuit part are meant equivalently.

Further details and advantages of the electromagnetic actuator of the disclosed kind will become apparent in the following description and the accompanying drawings.

In an advantageous embodiment, the outer magnetic circuit part can comprise two axially outer regions and a center region in-between, wherein a real magnetic flux density of a magnetic flux in the center region is at least 80% of the saturated magnetic flux density in the center region. Accordingly, the magnetic flux is or begins to be pushed out of the center region and a substantial stray field exists or is getting to exist. One effect of the special shape of the outer magnetic circuit part and the comparably high magnetic flux density in the center region is that diagonal or crossed pathways for the magnetic flux can be generated.

In more detailed words,
the inner magnetic circuit part can have a first ring shaped radially outer region at a first axial end of the inner magnetic circuit part and a second ring shaped radially outer region at a second axial end of the inner magnetic circuit part, which is located vis-à-vis of the first axial end,
a magnetic flux in a stray field of the magnet system can comprise a first magnetic flux component and a second magnetic flux component,
wherein the first magnetic flux component leaves the inner magnetic circuit part at its first ring shaped radially outer region and enters the outer magnetic circuit part in a second axial halve of the magnet system, which the second ring shaped radially outer region is part of, and
the second magnetic flux component leaves the outer magnetic circuit part in a first axial halve of the magnet system, which the first ring shaped radially outer region is part of, and enters the inner magnetic circuit part at its second ring shaped radially outer region.

Moreover, the first voice coil can be adjacent to the first ring shaped radially outer region of the inner magnetic circuit part, and a second voice coil can be adjacent to the second ring shaped radially outer region of the inner magnetic circuit part. In other words, the first voice coil can be arranged between the first ring shaped radially outer region of the inner magnetic circuit part and the outer magnetic circuit part, and the second voice coil can be arranged between the second ring shaped radially outer region of the inner magnetic circuit part and the outer magnetic circuit part.

Each of the first and the second magnetic flux component forms one diagonal magnetic flux component, or both magnetic flux components form crossed magnetic flux components. This is at least true in the magnetic idle position of the outer magnetic circuit part. When the outer magnetic circuit part is excursed, the magnetic flux changes and the crossed magnetic flux components can disappear as the case may be.

It is very advantageous if a magnetic flux density of the first magnetic flux component and the second magnetic flux component each is above 10% of the saturated magnetic flux density in the center region of the outer magnetic circuit part. Accordingly, the flux, which is edged out of the outer magnetic circuit part because of saturation or beginning saturation, has a certain and considerable flux density.

In yet another very advantageous embodiment, a virtual magnetic flux density of a magnetic flux in the center region, which is the magnetic flux generated in the magnet system divided by a cross sectional area of the center region in a plane perpendicular to the coil axis (in particular in a center plane of the outer magnetic circuit part), is at least 80% of the saturated magnetic flux density in the center region. The virtual flux density would exist in the center region if the complete magnetic flux generated in the magnet system passed through the center region. The virtual magnetic flux density in the center region may even be increased over the saturated magnetic flux density to influence the disclosed effect and to push the magnetic flux out of the center region to a higher extent. Further preferred ranges for the virtual magnetic flux density in the center region are more than 100% and more than 120% of the saturated magnetic flux density in the center region (note in this context that the real magnetic flux density in the center region does not go over 100%). Further on, the magnetic flux density of the first magnetic flux component and the second magnetic flux component each may be above 20% or 30% of the saturated magnetic flux density in the center region. In simple words, the higher the virtual magnetic flux density in the center region is, the more pronounced is the effect of the diagonal or crossed magnetic flux components.

One should generally note that the term “diagonal or crossed” in the context of the magnetic flux components does neither imply that the magnetic flux components are straight nor that the stray field is limited or concentrated to these magnetic flux components. Instead, the term “diagonal or crossed” is somewhat idealized to allow a focus on the principles of the electrodynamic actuator, and of course the magnetic flux components may have a curved course and the stray field may include other magnetic flux components.

Generally, the outer magnetic circuit part can have
A) a single stable magnetic idle position, wherein the magnetic idle position is defined as the position, in which the outer magnetic circuit part is situated in relation to the inner magnetic circuit part when no current flows through the voice coil(s) of the coil arrangement (and when no external force acts on the outer magnetic circuit part),
B) two spaced stable magnetic idle positions, wherein the magnetic idle positions are defined as the positions, in which the outer magnetic circuit part can be situated in relation to the inner magnetic circuit part when no current flows through the voice coil(s) of the coil arrangement (and when no external force acts on the outer magnetic circuit part), or
C) has an indifferent magnetic idle region, wherein the magnetic idle region is defined as a region with infinite magnetic idle positions, in which region the outer magnetic circuit part can be situated in relation to the inner magnetic circuit part when no current flows through the voice coil(s) of the coil arrangement (and when no external force acts on the outer magnetic circuit part).

That means that case A) describes a monostable design of the electrodynamic actuator, case B) a bistable design and case C) an design with an indifferent region, which can be seen as a region with infinite (adjacent) magnetic idle positions. In other words, this means equilibrium of the magnet force and the spring force in the magnetic idle position(s) or in the magnetic idle region. In yet other words, this means that a total force, which is the magnet force plus the spring force, is zero in the magnetic idle position(s) or in the magnetic idle region. Accordingly, a graph of the total force over an excursion of the outer magnetic circuit part or the coil arrangement respectively has a zero crossing or a zero passage. In case C), moreover, a total force gradient, which is defined as a differential of the total force over an excursion of the outer magnetic circuit part, is zero at least in sections of a graph of the total force gradient over the excursion of the outer magnetic circuit part or the coil arrangement respectively.

Generally, by design of the outer magnetic circuit part, the magnet force and in particular its course over the excursion of the outer magnetic circuit part can be further influenced. For example, the outer magnetic circuit part can comprise two axially outer regions and a center region in-between, wherein a cross section of the center region is smaller than a cross section of the outer regions, each seen in a cross-sectional plane perpendicular to the coil axis (a plane, which is relevant for the center region, in particular is the center plane of the outer magnetic circuit part). Accordingly, the magnetic flux is condensed in the center region and edged out of the center region at virtual magnetic flux densities close and above the saturation flux density in the center region. In other words, the magnetic flux density is influenced by the geometry of the outer magnetic circuit part (and not only by a strength of a magnet of the magnetic circuit). One should note that the center region may end at the voice coil(s) but may also extend beyond the same.

In one embodiment, the outer magnetic circuit part can comprise two axially outer regions and a center region in-between, in which the outer magnetic circuit part comprises an annular recess or groove on its radially inner boundary surface and/or on its radially outer boundary surface (running around the coil axis). This is a special form of the aforementioned center region with reduced cross section. One should note that the recess or groove does not necessarily have a constant depth but its depth may vary along an axial and/or circumferential extension of the outer magnetic circuit part. Moreover, the term “annular” in the context of the recess or groove may not be interpreted in a way that the recess or groove has to be continuous. Instead, the recess or groove may be broken. In particular, the term “annular” in the context of the recess or groove means that the recess or groove is present at least in 60% of the annular length of the outer magnetic circuit part or a “virtual” continuous annular recess or groove respectively. The recess or groove may even be limited to longitudinal sides of a polygonal (annular) outer magnetic circuit part or to its corners. In case of a rectangular outer magnetic circuit part, the recess or groove may be limited to a shorter or longer longitudinal side. In particular, the recess or groove can have a rectangular cross section, a square cross section, a triangular cross section or a trapezoid cross section each with or without angled and/or rounded edges. Further on, the recess or groove can have a curved shape like a semi-circle or a semi-ellipse or in general can have a concave shape respectively.

In another embodiment, the outer magnetic circuit part can comprise two axially outer regions and a center region in-between, in which the outer magnetic circuit part comprises an annular protrusion or ridge on its radially inner boundary surface and/or on its radially outer boundary surface (running around the coil axis). In this way, the airway for the aforementioned diagonal or crossed magnetic flux components can be reduced so that they occur at lower magnetic flux densities or are more pronounced respectively. One should note in this context that the annular protrusion or ridge does not necessarily have a constant height but its height may vary along axial and/or circumferential extension of the outer magnetic circuit part. Moreover, the term “annular” in the context of the annular protrusion or ridge may not be interpreted in a way that the annular protrusion or ridge has to be continuous. Instead, the annular protrusion or ridge may be broken. In particular, the term “annular” in the context of the annular protrusion or ridge means that the annular protrusion or ridge is present at least in 60% of the annular length of the outer magnetic circuit part or a “virtual” continuous annular protrusion or ridge respectively. The annular protrusion or ridge may even be limited to longitudinal sides of a polygonal (annular) outer magnetic circuit part or to its corners. In case of a rectangular outer magnetic circuit part, the annular protrusion or ridge may be limited to a shorter or longer longitudinal side. In particular, the protrusion or ridge can have a rectangular cross section, a square cross section, a triangular cross section or a trapezoid cross section each with or without angled and/or rounded edges. Further on, the protrusion or ridge can have a curved shape like a semi-circle or a semi-ellipse or in general can have a convex shape respectively.

In another beneficial embodiment, the electrodynamic actuator can comprise
I) a single annular protrusion or ridge on a radially inner boundary surface of the outer magnetic circuit part or
II) two distant annular protrusions or ridges on a radially inner boundary surface of the outer magnetic circuit part.

A single annular protrusion or ridge is easier to manufacture, whereas two distant protrusions or ridges lead to a more pronounced effect with regards to the aforementioned diagonal or crossed magnetic flux components.

In particular,
the annular protrusion or ridge in case I) can reach to both voice coils, and the annular protrusions or ridges in case II) each can reach one of the voice coils or
the annular protrusion or ridge in case I) can be distant from both voice coils, and the annular protrusions or ridges in case II) each can be distant from both voice coils.
   In the first embodiment, the voice coils are supported by the annular protrusion(s) or ridge(s) what on the one hand leads to a more robust construction of the electrodynamic actuator and on the other hand eases manufacturing of the electrodynamic actuator because the annular protrusion(s) or ridge(s) do also act as a stop. However, in the first embodiment, manufacturing tolerances of the coil arrangement and the outer magnetic circuit part may be compensated easier.

In yet another advantageous embodiment, the outer magnetic circuit part may comprise through holes at an axial center position of the outer magnetic circuit part or at an axial center plane of the outer magnetic circuit part respectively. The holes may be circular holes or slot holes. The holes, which are arranged in the outer magnetic circuit part may also vary in size, i.e. may have different diameter or length. It should be noted that this technical teaching also relates to blind holes, which however are considered as recesses for the concerns of this disclosure.

In one further embodiment
the outer magnetic circuit part can be made of a ferro-magnetic material and
the inner magnetic circuit part can comprise a center magnet, a bottom plate, which is arranged adjacent to the center magnet and which is made of a ferro-magnetic material, and a top plate, which is arranged adjacent to the center magnet and opposite of the bottom plate and which is made of a ferro-magnetic material as well.
   In this way, a proven structure is used for the proposed electrodynamic actuator, wherein the magnetic field is generated by the center magnet and guided by the other parts. For example, soft iron can be used as a ferro-magnetic material. However, other materials with corresponding properties may be used as well, in particular compound materials having plastics as one component.

Beneficially, a profile contour of an airgap between the outer magnetic circuit part and the inner magnetic circuit part in a cross sectional plane comprising the coil axis can be symmetric with respect to an axial center plane of the outer magnetic circuit part. In this way, equal behavior of the electrodynamic actuator is obtained for positive and negative excursion (measured from a magnetic idle position) of the outer magnet circuit part.

Beneficially, if sound is transmitted over the air, an average sound pressure level of the output device measured in an orthogonal distance of 10 cm from the sound emanating surface is at least 50 dB in a frequency range from 100 Hz to 15 kHz. “Average sound pressure level SPLAVG” in general means the integral of the sound pressure level SPL over a particular frequency range divided by said frequency range. In the above context, in detail the ratio between the sound pressure level SPL integrated over a frequency range from f=100 Hz to f=15 kHz and the frequency range from f=100 Hz to f=15 kHz is meant. In a more mathematical language this means:

$$S P {L}_{AVG} = \frac{{\int }_{f = 100}^{f = 15000} S P L \cdot df}{15 \; 000 - 100}$$

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows an oblique view of a first example of an electrodynamic actuator with an outer groove in the outer magnetic circuit part;

FIG. 2 shows a cross sectional view of the electrodynamic actuator of FIG. 1 connected to a sound emanating structure;

FIG. 3 shows an oblique view of the electrodynamic actuator of FIG. 1 with the spring arrangement being detached;

FIG. 4 shows an oblique view of an example of an electrodynamic actuator with a continuous annular outer magnetic circuit part;

FIG. 5 shows graphs of the magnetic force, the spring force and the total force, wherein the outer magnetic circuit part has a single stable magnetic idle position;

FIG. 6 is like FIG. 5 but with the outer magnetic circuit part having two single stable magnetic idle positions;

FIG. 7 is like FIG. 5 but with the outer magnetic circuit part having an indifferent magnetic idle region;

FIG. 8 shows a detailed cross sectional view of an electrodynamic actuator with an outer groove and inner ridges in the idle position of the outer magnetic circuit part;

FIG. 9 shows a detailed cross sectional view of the electrodynamic actuator of FIG. 8 in the excursed position of the outer magnetic circuit part;

FIG. 10 shows a cross sectional view of an electrodynamic actuator with detached spring arrangement with an inner and an outer groove in the outer magnetic circuit part;

FIG. 11 is like FIG. 10 but with grooves axially reaching beyond the voice coils;

FIG. 12 is like FIG. 11 but with an asymmetric center bar in the outer magnetic circuit part;

FIG. 13 shows an electrodynamic actuator with detached spring arrangement with a single inner ridge in the outer magnetic circuit part;

FIG. 14 like FIG. 13 but with an additional outer groove;

FIG. 15 shows an electrodynamic actuator with detached spring arrangement with two spaced inner ridges in the outer magnetic circuit part;

FIG. 16 shows an exemplary embodiment of an electrodynamic actuator with detached spring arrangement with just a single voice coil;

FIG. 17 shows an angular view of an electrodynamic actuator with detached spring arrangement with center through holes in the outer magnetic circuit part and

FIG. 18 shows a cross sectional view of the electrodynamic actuator of FIG. 17.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus,” “minus,” “upper,” “lower,” “upward,” “down-ward,” “left,” “right,” “leftward,” “rightward,” “front,” “rear,” “top,” “bottom,” “over,” “under,” “above,” “below,” “vertical,” “horizontal,” clockwise,” and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached,” “coupled,” “connected,” and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

All numbers expressing measurements and so forth used in the specification and claims are to be understood as being modified in all instances by the term “about” or “substantially,” which particularly means a deviation of +10% from a reference value.

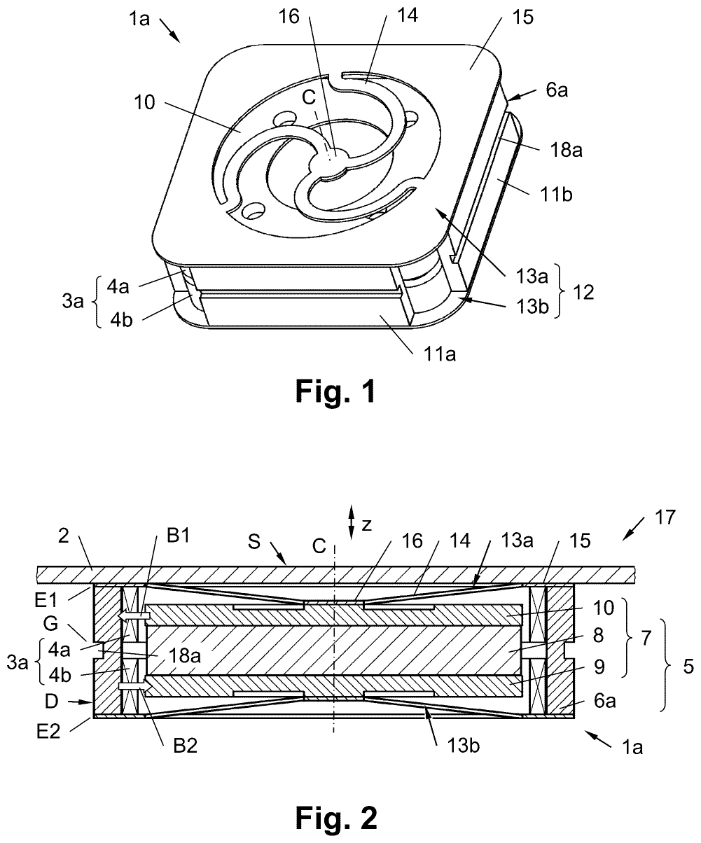

FIGS. 1 and 2 show a first example of an electrodynamic actuator 1a, which is designed to be acoustically coupled to a sound emanating structure 2. In detail, FIG. 1 shows an oblique view of the electrodynamic actuator 1a without the sound emanating structure 2, and FIG. 2 shows a cross sectional view of the electrodynamic actuator 1a, which is connected to a backside of the sound emanating structure 2 opposite to a sound emanating surface S of the sound emanating structure 2.

The electrodynamic actuator 1a comprises a coil arrangement 3a with two voice coils 4a, 4b, which have electrical conductors in the shape of loops running around a coil axis C in a loop section. In addition, the electrodynamic actuator 1a comprises a magnet system 5 with an outer magnetic circuit part 6a, which runs radially out of the coil arrangement 3a, wherein the coil arrangement 3a and the outer magnetic circuit part 6a are arranged in fixed relation to each other. In the given embodiment, the coil arrangement 3a is directly fixed to the outer magnetic circuit part 6a, for example, by means of glue. However, intermediate parts (e.g. frames and the like) between the coil arrangement 3a and the outer magnetic circuit part 6a may be used as well as the case may be.

Further on, the magnet system 5 comprises an inner magnetic circuit part 7, which is arranged radially within the coil arrangement 3a. The magnet system 5 is designed to generate a magnetic field B1, B2 transverse to the conductors of the voice coils 4a, 4b in the loop section, wherein the inner magnetic circuit part 7 in this example comprises a center magnet 8, a bottom plate 9 and a top plate 10. The bottom plate 9 is arranged adjacent to said center magnet 8, and the top plate 10 is arranged adjacent to said center magnet 8 and opposite of the bottom plate 9. The outer magnetic circuit part 6a is formed here by an outer plate arrangement, which surrounds the movable magnetic circuit part 7 and which in this example comprises four separate outer plates 11a . . . 11d. The outer plates 11a . . . 11d can be seen as a broken annular outer magnetic circuit part 6a. For example, the outer plates 11a . . . 11d of the outer magnetic circuit part 6a as well as the bottom plate 9 and the top plate 10 of the inner magnetic circuit part 7 can be made of a ferro-magnetic material, in particular of soft iron.

Further on, the electrodynamic actuator 1a comprises a spring arrangement 12, which couples the outer magnetic circuit part 6a to the inner magnetic circuit part 7 and allows a relative movement between the outer magnetic circuit part 6a and the inner magnetic circuit part 7 in an excursion direction z parallel to the coil axis C. In this example, the spring arrangement 12 comprises two springs 13a, 13b, each having spring legs 14, an (annular) outer holder 15 and a center holder 16. The outer holders 15 of the two springs 13a, 13b are connected to the outer plates 11a . . . 11d of the outer magnetic circuit part 6a. The center holder 16 of the first spring 13a is connected to the top plate 10 of the inner magnetic circuit part 7, and the center holder 16 of the second spring 13b is connected to the bottom plate 9 of the inner magnetic circuit part 7. The spring legs 14 each connect the outer holder 15 and the center holder 16 and allow a relative movement between the same and thus also between the outer magnetic circuit part 6a and the inner magnetic circuit part 7 and between the coil arrangement 3a and the inner magnetic circuit part 7 respectively. It should be noted that the spring arrangement 12 is not limited to the special design shown in FIG. 1, but other designs are possible as well.

In the example of FIG. 2 the outer magnetic circuit part 6a is arranged in fixed relation to the sound emanating structure 2. In detail, the sound emanating structure 2 may be a plate like structure, wherein the electromagnetic actuator 1a is connected to the backside of the sound emanating structure 2 like this is the case in the embodiment shown in FIG. 2. In more detail, the outer holder 15 of the first spring 13a is mounted to the backside of the sound emanating structure 2, for example, by means of a glue layer. Because the outer magnetic circuit part 6a is arranged in fixed relation to the sound emanating structure 2, the outer magnetic circuit part 6a can also be seen and denoted as fixed magnetic circuit part 6a in this embodiment. Accordingly, because the inner magnetic circuit part 7 may move in relation to the outer magnetic circuit part 6a, it can be seen and denoted as movable magnetic circuit part 6a in this embodiment. However, one should note that the outer magnetic circuit part 6a and the inner magnetic circuit part 7 may be arranged the other way around, and their roles may change. In other words, the inner magnetic circuit part 7 may be arranged in fixed relation to the sound emanating structure 2, for example, when the center holder 16 of the first spring 13a is mounted to the backside of the sound emanating structure 2. To obtain a long life connection between the electromagnetic actuator 1a and the plate like structure 2, the electromagnetic actuator 1a can comprise a flat mounting surface, which is intended to be connected to the backside the plate like structure 2 opposite to the sound emanating surface S like this is the case in the example of FIG. 2.

Generally, the electrodynamic actuator 1a is designed to be built into an output device 17 and to be acoustically coupled to a sound emanating structure 2 of the output device 17. In this way, the electrodynamic actuator 1a together with the plate like structure 2 forms an output device 17.

For example, the sound emanating structure 2 may be a plate like structure, which in particular can be embodied as a display, wherein the electromagnetic actuator 1a is connected to the backside of the display. In this case, the output device 17 can output both audio and video data. In this embodiment, sound is transmitted over the air. Beneficially, an average sound pressure level of the output device 17 measured in an orthogonal distance of 10 cm from the sound emanating surface S is at least 50 dB_SPL in a frequency range from 100 Hz to 15 kHz.

In another embodiment, the sound emanating structure 2 may be a housing of the output device 17, which is designed for bone conduction or to contact a head of a user wearing the output device 17 respectively. In this case, the electrodynamic actuator 1a is built into the output device 17 and acoustically coupled to the housing 2. For example, the output device 17 can be embodied as a headphone or a hearing aid. In this embodiment, sound is transmitted via bone conduction (i.e. via the skull of the user), and the sound emanating surface S is the surface, which is intended to contact the user's head. One should note in this context, that the user head does not need to contact the sound emanating surface S directly vis-à-vis of the electrodynamic actuator 1a but may contact the sound emanating surface S away from the electrodynamic actuator 1a.

In both embodiments, sound is generated in particular by the inertia of the movable magnetic circuit part (which is the inner magnetic circuit part 7 in this example) and in more detail by the (total) force acting between the inner magnetic circuit part 7 and the outer magnetic circuit part 6a when a relative movement between the same is initiated.

Generally, one should also note that sound in the second embodiment may even be audible via air. However, the intended sound transmission in the second embodiment is sound transmission via bone conduction. Equally, in the first embodiment, sound may even be audible via bone conduction. However, the intended sound transmission in the first embodiment is sound transmission via air.

With regards to the sound emanating surface S, one should note that sound can also emanate from the backside of the sound emanating structure 2, i.e. the side opposite of the sound emanating surface S. However, this backside usually faces an interior space of a device (e.g. a mobile phone), which the output device 17 is built into. Hence, the sound emanating structure 2 may be considered to have the main sound emanating surface S and a secondary sound emanating surface (i.e. said backside). Sound waves emanated by the main sound emanating surface S directly reach the user's ear, whereas sound waves emanated by the secondary sound emanating surface do not directly reach the user's ear, but only indirectly via reflection or excitation of other surfaces of a housing of the output device 17. This is particularly true in case of sound transmission over the air but less in case of bone conduction, where sound waves within the output device 17 can move within interconnected parts of the output device 17.

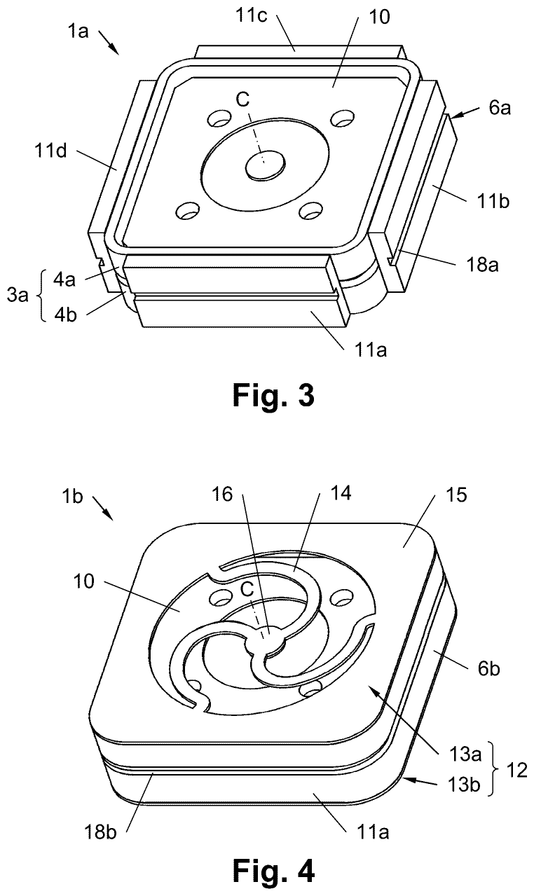

FIG. 3 in addition shows an oblique view of the electrodynamic actuator 1a with the springs 13a, 13b being detached so as to allow a better view into the interior of the electrodynamic actuator 1a.

FIG. 4 shows an oblique view of a second example of an electrodynamic actuator 1b, which is similar to the electrodynamic actuator 1a shown in FIGS. 1 to 3. In contrast, the outer plate arrangement 6b is formed by a single annular outer plate 11, and the outer magnetic circuit part 6b is a continuous annular outer magnetic circuit part 6a, whereas the outer magnetic circuit part 6a is an approximated or broken annular outer magnetic circuit part 6a. Nevertheless, the cross sectional view of the electrodynamic actuator 1a applies to the electrodynamic actuator 1b as well.

Generally, the magnet system 5 upon excitation of the coil arrangement 3a causes a magnet force F_{M} acting between the inner magnetic circuit part 7 and the outer magnetic circuit part 6a, 6b in a magnet force direction parallel to the coil axis C, and the spring arrangement 12 upon excitation of the coil arrangement 3a causes a spring force F_{S} acting between the inner magnetic circuit part 7 and the outer magnetic circuit part 6a, 6b in a spring force direction, which is parallel to the coil axis C as well.

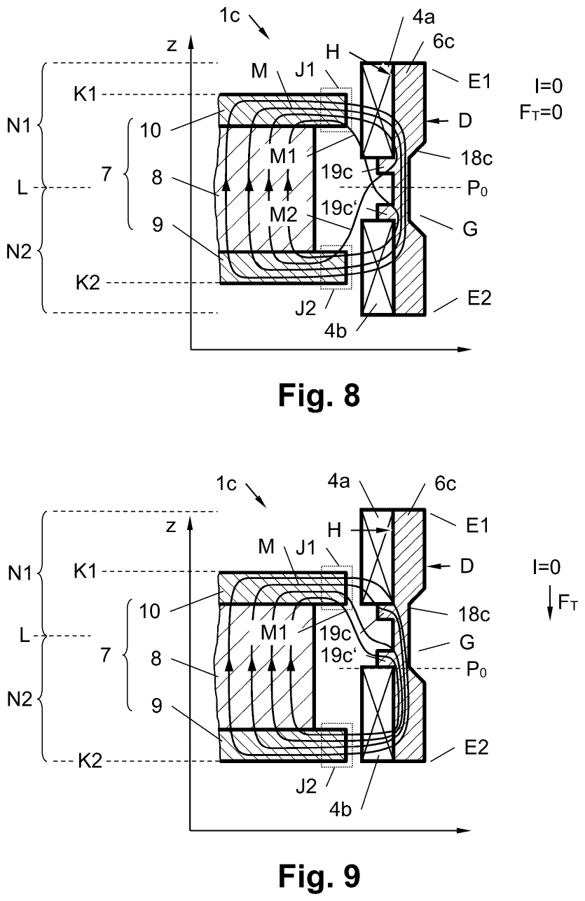

Moreover, generally, the magnet force F_{M} and the spring force F_{S} are opposed. In more detail this means that the spring force F_{S} points to a magnetic idle position P₀ of the outer magnetic circuit part 6a, 6b and the magnet force F_{M} points away from the magnetic idle position P₀, wherein the magnetic idle position P₀ is defined as the position, in which the outer magnetic circuit part 6a, 6b is situated in relation to the inner magnetic circuit part 7 when no current flows through the voice coils 4a, 4b of the coil arrangement 3a and when no external force acts on the outer magnetic circuit part 6a, 6b (see also FIGS. 8 and 9 in this context).

This phenomenon in the example of FIGS. 1 to 4 is based on an annular recess or groove 18a, 18b on the radially outer boundary surface D of the outer magnetic circuit part 6a, 6b. In more general words, the (annular) outer magnetic circuit part 6a, 6b can comprise two axially outer regions E1, E2 and a center region G in-between, in which the outer magnetic circuit part 6a, 6b comprises the annular recess or groove 18a, 18b on its radially outer boundary surface D. In even more general words, a cross section of the center region G can be smaller than a cross section of the outer regions E1, E2, each seen in a cross-sectional plane perpendicular to the coil axis C (i.e. in a viewing direction along the coil axis C). In particular, the cross-sectional plane, which is relevant for the center region G, can be the center plane L of the outer magnetic circuit part 6a, 6b (see FIG. 8 in this context).

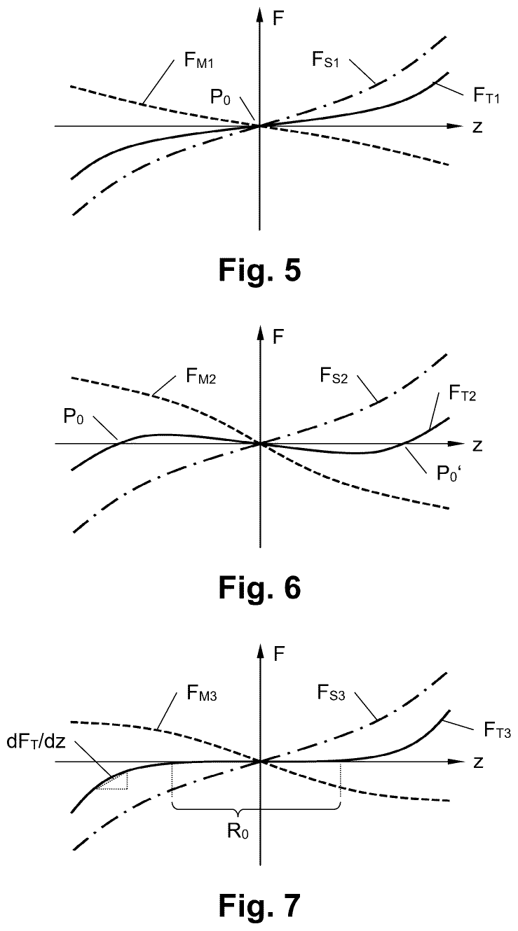

FIGS. 5 to 7 in this context show three general and exemplary diagrams of a total force F_{T}, which is the magnet force F_{M} plus the spring force F_{S}, over the excursion z of the outer magnetic circuit part 6a, 6b (or the coil arrangement 3a respectively) in direction of the coil axis C. FIG. 5 shows a case, where the outer magnetic circuit part 6a, 6b has a single stable magnetic idle position P₀ In the center of the excursion range of the outer magnetic circuit part 6a, 6b (case A). FIG. 6 shows a case, where the outer magnetic circuit part 6a, 6b has two spaced stable magnetic idle positions P₀, P₀′ around the center of the excursion range of the outer magnetic circuit part 6a, 6b (case B). FIG. 7 finally shows a case, where the outer magnetic circuit part 6a, 6b has an indifferent magnetic idle region R₀ around the center of the excursion range of the outer magnetic circuit part 6a, 6b (case C). The indifferent magnetic idle region R₀ can be seen as a region with infinite magnetic idle positions P₀, P₀′. Note that an excursion z of the outer magnetic circuit part 6a, 6b implies an excursion z of the coil arrangement 3a, too, because they are fixedly arranged to each other.

Beneficially, a total force gradient dF_{T}/dz, which is the differential of the total force F_{T}, F_{T1} . . . F_{T3} over an excursion z of the outer magnetic circuit part 6a, 6b, is zero at least in sections of a graph of the total force gradient dF_{T}/dz over the excursion z of the outer magnetic circuit part 6a, 6b. This condition, for example, is true for the indifferent magnetic idle region R₀.

One should generally note and in particular context of FIGS. 5 to 7 that the magnet force F_{M} acting on the outer magnetic circuit part 6a, 6b and the spring force F_{S} acting on the outer magnetic circuit part 6a, 6b cause corresponding counter forces acting on the inner magnetic circuit part 7. So, similar diagrams of a total force F_{T}, a magnet force F_{M} and a spring force F_{S} over the excursion z can be drawn for the inner magnetic circuit part 7. Basically, the force directions for the inner magnetic circuit part 7 are opposite to those for the outer magnetic circuit part 6a, 6b. However, for the reason of simplicity, reference is made only to the forces F acting on the outer magnetic circuit part 6a, 6b, wherein also forces F acting on the inner magnetic circuit part 7 are meant equivalently.

The magnetic force F_{M}, the spring force F_{S} and the total force F_{T} may have a linear, a progressive or a degressive course over the excursion z of the outer magnetic circuit part 6a, 6b, for example. The characteristics may also be mixed to obtain a desired course of the total force F_{M}. For example, a progressive magnetic force F_{M} can be combined with a degressive spring force F_{S} or vice versa, or a progressive magnetic force F_{M} can be combined with a linear spring force F_{S} or vice versa.

Generally, the courses of the magnet force F_{M} can be shaped by appropriate design of the outer magnetic circuit part 6a, 6b and the spring force F_{S} can be shaped by appropriate design of the spring arrangement 12. The latter is generally known and not explained in more detail at this point, whereas possible designs of the outer magnetic circuit part 6c . . . 6k are discussed hereinafter now.

FIGS. 8 and 9 show a detailed cross sectional view of an electrodynamic actuator 1c, which is similar to the electrodynamic actuators 1a, 1b shown in FIGS. 1 to 4, in different states, that is at different positions of the outer magnetic circuit part 6c. In detail, FIG. 8 shows the outer magnetic circuit part 6c in its magnetic idle position P₀ when no current I flows through the voice coils 4a, 4b, and FIG. 9 shows the outer magnetic circuit part 6c in an excursed position, i.e. displaced from its idle position P₀ in the z-direction or excursion direction. If the outer magnetic circuit part 6c is excursed, the total force Fr points to the (or one of the) magnetic idle position P₀. FIGS. 8 and 9 also show how the magnetic flux M runs.

One should generally note and in particular context of FIGS. 8 and 9 that the magnetic idle position P₀ in this disclosure refers to the outer magnetic circuit part 6a . . . 6c. However, strictly speaking, a relative magnetic idle position P₀ between the inner magnetic circuit part 7 and the outer magnetic circuit part 6a . . . 6c is meant. So, similar considerations can be made for a magnetic idle position P₀ of the inner magnetic circuit part 7.

As is visible from FIGS. 8 and 9, seen in a cross-sectional plane perpendicular to the coil axis C (such a plane, for example, is a horizontal plane perpendicular to the image plane of FIG. 8) or in a viewing direction along the coil axis C respectively, a cross section of the center region G of the outer magnetic circuit part 6c (in particular at the position P₀) is smaller than a cross section of the outer regions E1, E2 of the outer magnetic circuit part 6c. Or in other words, the outer magnetic circuit part 6c comprises an annular recess or groove 18c on its radially outer boundary surface D with sloping edges and around the coil axis C. In addition, the outer magnetic circuit part 6c in its center region G comprises two distant annular protrusions or ridges 19c, 19c′ on its radially inner boundary surface H and around the coil axis C, wherein the annular protrusions or ridges 19c, 19c′ each reach one of the voice coils 4a, 4b.

A real magnetic flux density of the magnetic flux M in the center region G between the two axially outer regions E1, E2 preferably is at least 80% of the saturated magnetic flux density in the center region G. In another variant, a virtual magnetic flux density of the magnetic flux M in the center region G between the two axially outer regions E1, E2 preferably is at least 80% of the saturated magnetic flux density in the center region G, wherein said virtual magnetic flux density is the magnetic flux M generated in the magnet system 5 divided by a cross sectional area of the center region G in a plane perpendicular to the coil axis C (such a plane, for example, again is a horizontal plane perpendicular to the image plane of FIG. 8, in particular at the position P₀). In other words the virtual flux density would exist in the center region G if the complete magnetic flux M generated by the center magnet 8 passed through the center region G. However, the real magnetic flux density in the center region G cannot go beyond the saturated magnetic flux density, and thus at least the share of the virtual magnetic flux density over the saturated magnetic flux density forms the stray field. Based on this magnetic flux density, magnetic flux lines are very dense in the center region G and the magnetic flux M is or begins to be pushed out of the center region G in FIG. 8. In other words, a substantial stray field exists or is getting to exist.

One effect of the special shape of the outer magnetic circuit part 6c and the comparably high magnetic flux density in the center region G is that diagonal or crossed pathways for the magnetic flux M are generated in this example.

In more detailed words,
the inner magnetic circuit part 7 has a first ring shaped radially outer region J1 at a first axial end K1 of the inner magnetic circuit part 7 and a second ring shaped radially outer region J2 at a second axial end K2 of the inner magnetic circuit part 7, which is located vis-à-vis of the first axial end K1,
a magnetic flux M in a stray field of the magnet system 5 comprises a first magnetic flux component M1 and a second magnetic flux component M2,
the first magnetic flux component M1 leaves the inner magnetic circuit part 7 at its first ring shaped radially outer region J1 and enters the outer magnetic circuit part 6c in a second axial halve N2 of the magnet system 5, which the second ring shaped radially outer region J2 is part of, and
the second magnetic flux component M2 leaves the outer magnetic circuit part 6c in a first axial halve N1 of the magnet system 5, which the first ring shaped radially outer region J1 is part of, and enters the inner magnetic circuit part 7 at its second ring shaped radially outer region J2.

In FIGS. 8 and 9 the first axial halve N1 is arranged above the axial center plane L of the outer magnetic circuit part 6c, and the second axial halve N2 is arranged below the axial center plane L of the outer magnetic circuit part 6c.

Moreover, the first voice coil 4a is adjacent to the first ring shaped radially outer region J1 of the inner magnetic circuit part 7, and a second voice coil 4b is adjacent to the second ring shaped radially outer region J2 of the inner magnetic circuit part 7. In other words, the first voice coil 4a is arranged between the first ring shaped radially outer region J1 of the inner magnetic circuit part 7 and the outer magnetic circuit part 6c, and the second voice coil 4b is arranged between the second ring shaped radially outer region J2 of the inner magnetic circuit part 7 and the outer magnetic circuit part 6c.

Each of the first and the second magnetic flux component M1, M2 forms one diagonal magnetic flux component, or both magnetic flux components M1, M2 form crossed magnetic flux components. If the center magnet 8 is magnetized in an opposite direction, the magnetic flux M and its magnetic flux components M1, M2 are reversed accordingly. When the outer magnetic circuit part 6c is excursed, the magnetic flux M changes and the crossed magnetic flux components M1, M2 can disappear what is depicted in FIG. 9.

The special shape of the outer magnetic circuit part 6c and the comparably high magnetic flux density in the center region G are reasons that the magnetic force F_{M} changes its direction in view of know designs so that the spring force F_{S} and the magnetic force F_{M} have opposite directions like this is the case in the examples of FIGS. 5 to 7.

As said, one influencing factor is the design of the outer magnetic circuit part 6c, by which the shape of the courses of the magnet force F_{M} can be influenced accordingly in the examples of FIGS. 5 to 7.

Another influencing factor is the (real or virtual) magnetic flux density in the center region G, which as said preferably is at least 80% of the saturated magnetic flux density in the center region G. Further on, preferably a magnetic flux density of the first magnetic flux component M1 and the second magnetic flux component M2 each is above 10% of the saturated magnetic flux density in the center region G. However, the virtual magnetic flux density in the center region G may even be increased over the saturated magnetic flux density to influence the disclosed effect and to push the magnetic flux M out of the center region G to a higher extent. Further preferred ranges for the virtual magnetic flux density in the center region G are more than 100% and more than 120% of the saturated magnetic flux density in the center region G. Further on, the magnetic flux density of the first magnetic flux component M1 and the second magnetic flux component M2 each may be above 20% or 30% of the saturated magnetic flux density in the center region G. In simple words, the higher the virtual flux density in the center region G is, the more pronounced is the effect of the diagonal or crossed magnetic flux components M1, M2.

One should generally note that the magnetic flux lines in FIGS. 8 and 9 are just schematic and idealized to allow a focus on the principles of the electrodynamic actuator 1c, and magnetic fluxes M in reality may deviate from the ones depicted in FIGS. 8 and 9.

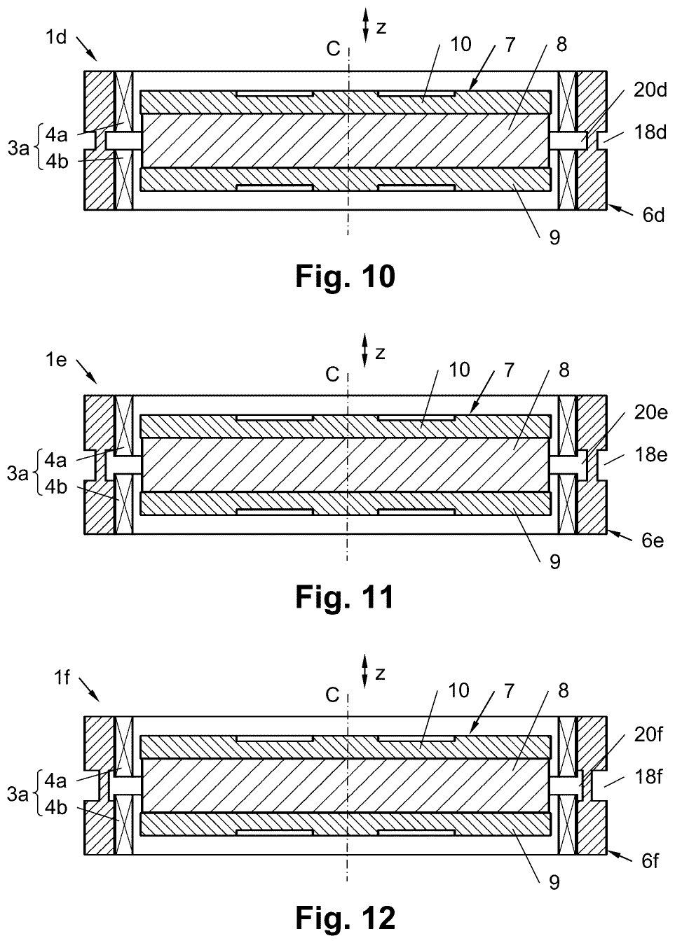

FIGS. 10 to 18 show cross sectional views of further examples of electrodynamic actuators 1d . . . 1k, wherein one should note that the spring arrangements 12 between the inner magnetic circuit parts 7 and the outer magnetic circuit parts 6d . . . 6k are left out in FIGS. 10 to 18. However, in reality the spring arrangements 12 between the inner magnetic circuit parts 7 and the outer magnetic circuit parts 6d . . . 6j exists.

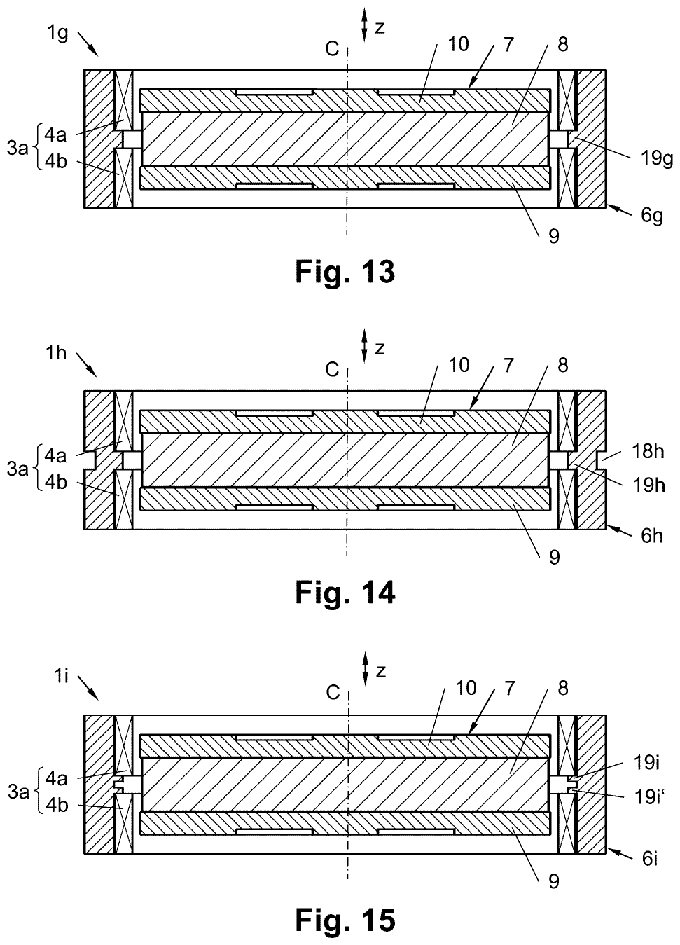

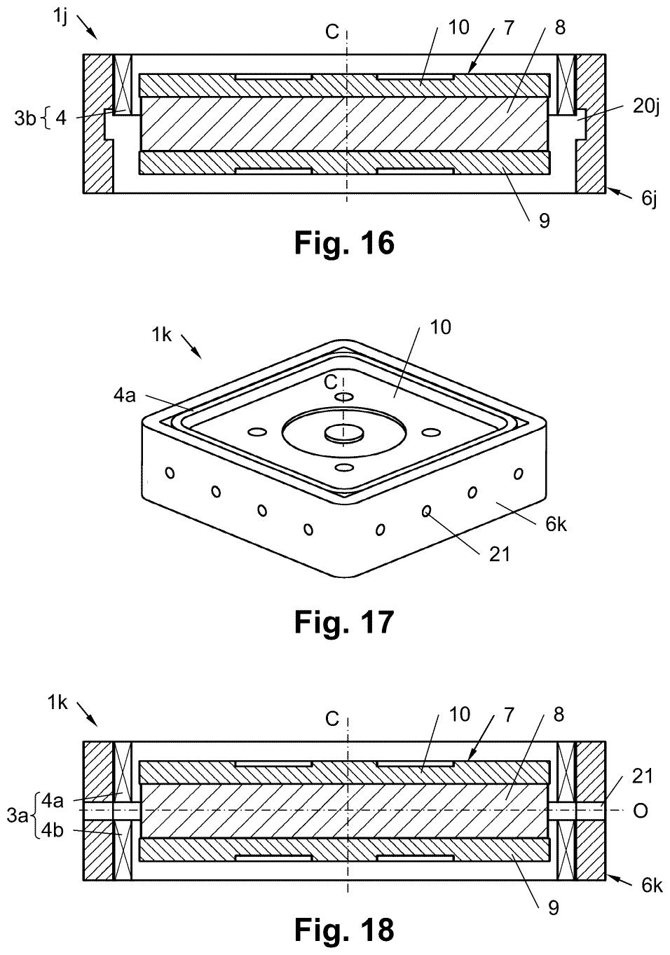

FIG. 10 shows an electrodynamic actuator 1d, which is similar to the electrodynamic actuators 1a, 1b of FIGS. 1 to 4, but where the outer magnetic circuit part 6d comprises annular recesses or grooves 18d, 20d both on its radially inner boundary surface H and on its radially outer boundary surface D. FIG. 11 shows an electrodynamic actuator 1e, which is similar to the electrodynamic actuator 1d of FIG. 10, but where the recesses or grooves 18e, 20e axially reach beyond the voice coils 4a, 4b. FIG. 12 shows an electrodynamic actuator 1f, which is similar to the electrodynamic actuator 1e of FIG. 11. In contrast, the middle bar (or middle ring respectively) of the center region G is asymmetric. FIG. 13 shows an electrodynamic actuator 1g with a single annular protrusion or ridge 19g on a radially inner boundary surface H of the annular outer magnetic circuit part 6g, wherein the single annular protrusion or ridge 19g reaches to both voice coils 4a, 4b. FIG. 14 shows an electrodynamic actuator 1h, which basically is a combination of the electrodynamic actuator 1a of FIGS. 1 to 3 or the electrodynamic actuator 1b of FIG. 4 and the electrodynamic actuator 1g of FIG. 13. In detail, the electrodynamic actuator 1h comprises a recess or groove 18h on its radially outer boundary surface D and a single annular protrusion or ridge 19h on its radially inner boundary surface H. FIG. 15 shows another electrodynamic actuator 1i, which is similar to the electrodynamic actuator 1c of FIGS. 8 and 9, but without a recess or groove 18c on the radially outer boundary surface D. In detail, the electrodynamic actuator 1i comprises two annular protrusions or ridges 19i, 19i′ on its radially inner boundary surface H. FIG. 16 shows yet another electrodynamic actuator 1j, which is similar to the electrodynamic actuators 1a, 1b of FIGS. 1 to 4, but which has just a single voice coil 4.

The recesses or grooves 18a . . . 18h, 20d . . . 20j shown in FIGS. 1 to 4, 8 to 12, 14 and 16 in particular may have a rectangular cross section, a square cross section, a triangular cross section or a trapezoid cross section each with or without sloped and/or rounded edges. Further on, the recesses or grooves 18a . . . 18h, 20d . . . 20j can have a curved shape like a semi-circle or a semi-ellipse or in general can have a concave shape respectively.

Similarly, the protrusions or ridges 19c . . . 19i′ shown in FIGS. 8 and 9, and 13 to 15 in particular may have a rectangular cross section, a square cross section, a triangular cross section or a trapezoid cross section each with or without sloped and/or rounded edges. Further on, the protrusions or ridges 19c . . . 19i′ can have a curved shape like a semi-circle or a semi-ellipse or in general can have a convex shape respectively.

In FIGS. 13 to 15, the annular protrusion(s) 19g . . . 19i′ reach(es) to both voice coils 4a, 4b. Hence, the voice coils 4a, 4b are supported by the annular protrusion(s) 19g . . . 19i′ what on the one hand leads to a more robust construction of the electrodynamic actuator 1g . . . 1i and on the other hand eases manufacturing of the electrodynamic actuator 1g . . . 1i because the annular protrusion(s) 19g . . . 19i′ do also act as a stop. However, the annular protrusion(s) 19g . . . 19i′ may also be distant from both voice coils 4a, 4b. In this way, manufacturing tolerances of the coil arrangement 12 and the outer magnetic circuit part 6g . . . 6i may be compensated easier.

Generally, it is of advantage if a profile contour of an airgap between the outer magnetic circuit part 6a . . . 6i and the inner magnetic circuit part 7 in a cross sectional plane comprising the coil axis C (such a plane, for example, is the image plane of FIG. 8) is symmetric with respect to an axial center plane N of the outer magnetic circuit part 6a . . . 6i (this plane is perpendicular to the coil axis C). In this way, equal behavior of the electrodynamic actuator 1a . . . 1i is obtained for positive and negative excursions z.

FIGS. 17 and 18 finally show a further example of an electrodynamic actuator 1k, where the outer magnetic circuit part 7k comprises through holes 21 at an axial center position O of the outer magnetic circuit part 7j or in the axial center plane L of the outer magnetic circuit part 7j respectively (see FIG. 8 in this context). FIG. 17 shows an angled view and FIG. 18 a cross sectional view of the electrodynamic actuator 1k. In the example of FIGS. 17 and 18, circular holes are shown, however, slot holes may be used as well as the case may be.

The aforementioned measures can be used in any desired combination. So for example, the trapezoid recess or groove 18c of FIGS. 8 and 9 may be combined with the single protrusion or ridge 19h of FIG. 14. Similarly, the protrusions or ridges 19c, 19c′, 19i, 19i′ of FIGS. 8, 9 and 15 may be used without a recess or groove 18c. The recess or groove 18h of FIG. 14 may axially reach beyond the voice coils 4a, 4b like this is the case in FIGS. 11 and 12, and so on. In addition, through holes 21 may be combined with (outer) recesses or grooves 18a . . . 18h, (inner) recesses or grooves 20d . . . 20j and/or protrusions or ridges 19c . . . 19i′. It should also be noted that different cross sections for the (outer) recesses or grooves 18a . . . 18h, (inner) recesses or grooves 20d . . . 20j and/or protrusions or ridges 19c . . . 19i′ may be mixed, i.e. rectangular cross sections, square cross sections, triangular cross sections, trapezoid cross sections, semi-circular cross sections and/or semi-elliptical cross sections.

By the proposed measures, the total force Fr is substantially influenced by the magnet system 5. Accordingly, limitations of the spring arrangement 12 can be overcome or can be compensated. In particular, the resonance frequency of an electromagnetic actuator 1a . . . 1k and an output device 17 can be lowered without limiting use and lifetime, or the measures can be used or to improve use and to increase lifetime without increasing the resonance frequency. In a nutshell, the proposed solutions offer more design freedom in terms of reaching a desired output power, a desired sound quality and a desired lifetime of an electromagnetic actuator 1a . . . 1k and an output device 17.

Finally, one should note that the invention is not limited to the above-mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

LIST OF REFERENCES

| | |
|---|---|
| 1a . . . 1k | electromagnetic actuator |
| 2 | sound emanating structure of output device |
| 3a, 3b | (annular) coil arrangement |
| 4, 4a, 4b | voice coil |
| 5 | magnet system |
| 6a . . . 6k | (annular) outer magnetic circuit part |
| 7 | inner magnetic circuit part |
| 8 | center magnet |
| 9 | bottom plate |
| 10 | top plate |
| 11a . . . 11d | outer plate |
| 12 | spring arrangement |
| 13a, 13b | spring |
| 14 | spring leg |
| 15 | (annular) outer holder |
| 16 | center holder |
| 17 | output device |
| 18a . . . 18h | (outer) recess or groove |
| 19c . . . 19i′ | protrusion or ridge |
| 20d . . . 20j | (inner) recess or groove |
| 21 | through hole |
| B1, B2 | magnetic field |
| C | coil axis (actuator axis) |
| D | radially outer boundary surface of |
| | outer magnetic circuit part |
| E1, E2 | axially outer region of outer |
| | magnetic circuit part |
| F | force |
| F_{M}, F_{M1} . . . F_{M3} | magnet force |
| F_{S}, F_{S1} . . . F_{S3} | spring force |
| F_{T}, F_{T1} . . . F_{T3} | total force |
| dF_{T}/dz | total force gradient |
| G | center region of outer magnetic circuit part |
| H | radially inner boundary surface of |
| | outer magnetic circuit part. |
| I | current |
| J1, J2 | ring shaped radially outer region of |
| | inner magnetic circuit part |
| K1, K2 | axial end of inner magnetic circuit part |
| L | axial center plane of the outer |
| | magnetic circuit part |
| M | magnetic flux |
| M1, M2 | magnetic flux component |
| N1, N2 | axial halve of magnet system |
| O | axial center position of outer |
| | magnetic circuit part |
| P₀, P₀′ | magnetic idle position |
| R₀ | indifferent magnetic idle region |
| S | (main) sound emanating surface |
| z | excursion |

What is claimed is:

1. An electrodynamic actuator (1a . . . 1k), which is designed to be built into an output device (17) and to be acoustically coupled to a sound emanating structure (2) of the output device (17), wherein the electrodynamic actuator (1a . . . 1k) comprises a coil arrangement (3a, 3b), a magnet system (5) and a spring arrangement (12), wherein
the coil arrangement (3a, 3b) comprises at least one voice coil (4, 4a, 4b) having an electrical conductor in the shape of loops running around a coil axis (C) in a loop section,
the magnet system (5) comprises an outer magnetic circuit part (6a . . . 6k), which runs radially out of the coil arrangement (3a, 3b),
the coil arrangement (3a, 3b) and the outer magnetic circuit part (6a . . . 6k) are arranged in fixed relation to each other,
the magnet system (5) comprises an inner magnetic circuit part (7), which is arranged radially within the coil arrangement (3a, 3b),
the magnet system (5) is designed to generate a magnetic field (B1, B2) transverse to the electrical conductor in the loop section,
the spring arrangement (12) couples the inner magnetic circuit part (7) to the outer magnetic circuit part (6a . . . 6k) and allows a relative movement between the inner magnetic circuit part (7) and the outer magnetic circuit part (6a . . . 6k) in an excursion direction (z) parallel to the coil axis (C),
the magnet system (5) upon excitation of the outer magnetic circuit part (6a . . . 6k) causes a magnet force (F_{M}, F_{M1} . . . F_{M3}) acting between the inner magnetic circuit part (7) and the outer magnetic circuit part (6a . . . 6k) in a magnet force direction parallel to the coil axis (C), and
the spring arrangement (12) upon excitation of the outer magnetic circuit part (6a . . . 6k) causes a spring force (F_{S}, F_{S1} . . . F_{S3}) acting between the inner magnetic circuit part (7) and the outer magnetic circuit part (6a . . . 6k) in a spring force direction parallel to the coil axis (C),
wherein the magnet force (F_{M}, F_{M1} . . . F_{M3}) and the spring force (F_{S}, F_{S1} . . . F_{S3}) are opposed.

2. The electrodynamic actuator (1a . . . 1k) as claimed in claim 1, wherein the spring force (F_{S}, F_{S1} . . . F_{S3}) acting on the outer magnetic circuit part (6a . . . 6k) points to a magnetic idle position (P₀, P₀′) of the outer magnetic circuit part (6a . . . 6k) and the magnet force (F_{M}, F_{M1} . . . F_{M3}) acting on the outer magnetic circuit part (6a . . . 6k) points away from the magnetic idle position (P₀, P₀′), wherein the magnetic idle position (P₀, P₀′) is defined as the position, in which the outer magnetic circuit part (6a . . . 6k) is situated in relation to the inner magnetic circuit part (7) when no current (I) flows through the voice coil(s) (4, 4a, 4b) of the coil arrangement (3a, 3b).

3. The electrodynamic actuator (1a . . . 1k) as claimed in claim 1, wherein the outer magnetic circuit part (6a . . . 6k) comprises two axially outer regions (E1, E2) and a center region (G) in-between, and a real magnetic flux density of a magnetic flux (M) in the center region (G) is at least 80% of the saturated magnetic flux density in the center region (G).

4. The electrodynamic actuator (1a . . . 1k) as claimed in claim 1, wherein the outer magnetic circuit part (6a . . . 6k) comprises two axially outer regions (E1, E2) and a center region (G) in-between, and a virtual magnetic flux density of a magnetic flux (M) in the center region (G), which is the magnetic flux (M) generated in the magnet system (5) divided by a cross sectional area of the center region (G) in a plane perpendicular to the coil axis (C), is at least 80% of the saturated magnetic flux density in the center region (G).

5. The electrodynamic actuator (1a . . . 1k) as claimed in claim 1, wherein:
the inner magnetic circuit part (7) has a first ring shaped radially outer region (J1) at a first axial end (K1) of the inner magnetic circuit part (7) and a second ring shaped radially outer region (J2) at a second axial end (K2) of the inner magnetic circuit part (7), which is located vis-à-vis of the first axial end (K1),
a magnetic flux (M) in a stray field of the magnet system (5) comprises a first magnetic flux component (M1) and a second magnetic flux component (M2),
the first magnetic flux component (M1) leaves the inner magnetic circuit part (7) at its first ring shaped radially outer region (J1) and enters the outer magnetic circuit part (6a . . . 6k) in a second axial halve (N2) of the magnet system (5), which the second ring shaped radially outer region (J2) is part of, and
the second magnetic flux component (M2) leaves the outer magnetic circuit part (6a . . . 6k) in a first axial halve (N1) of the magnet system (5), which the first ring shaped radially outer region (J1) is part of, and enters the inner magnetic circuit part (7) at its second ring shaped radially outer region (J2).

6. The electrodynamic actuator (1a . . . 1k) as claimed in claim 5, wherein a magnetic flux density of the first magnetic flux component (M1) and the second magnetic flux component (M1) each is above 10% of the saturated magnetic flux density in the center region (G) of the outer magnetic circuit part (6a . . . 6k).

7. The electrodynamic actuator (1a . . . 1k) as claimed in claim 5, wherein
in a case i) the coil arrangement (3a, 3b) comprises a single voice coil (4), which is arranged between the first ring shaped radially outer region (J1) and the outer magnetic circuit part (6a . . . 6k), or
in a case ii) the coil arrangement (3a, 3b) comprises a first voice coil (4a) between the first ring shaped radially outer region (J1) and the outer magnetic circuit part (6a . . . 6k) and a second voice coil (4b) between the second ring shaped radially outer region (J2) and the outer magnetic circuit part (6a . . . 6k).

8. The electrodynamic actuator (1a . . . 1k) as claimed in claim 1, wherein the outer magnetic circuit part (6a . . . 6k) has:
A) a single stable magnetic idle position (P₀), wherein the magnetic idle position (P₀) is defined as the position, in which the outer magnetic circuit part (6a . . . 6k) is situated in relation to the inner magnetic circuit part (7) when no current flows through the voice coil(s) (4, 4a, 4b) of the coil arrangement (3a, 3b),
B) two spaced stable magnetic idle positions (P₀, P₀′), wherein the magnetic idle positions (P₀, P₀′) are defined as the positions, in which the outer magnetic circuit part (6a . . . 6k) can be situated in relation to the inner magnetic circuit part (7) when no current flows through the voice coil(s) (4, 4a, 4b) of the coil arrangement (3a, 3b); or
C) an indifferent magnetic idle region (R₀), wherein the magnetic idle region (R₀) is defined as a region with infinite magnetic idle positions (P₀, P₀′), in which region the outer magnetic circuit part (6a . . . 6k) can be situated in relation to the inner magnetic circuit part (7) when no current flows through the voice coil(s) (4, 4a, 4b) of the coil arrangement (3a, 3b).

9. The electrodynamic actuator (1a . . . 1k) as claimed in claim 1, wherein:
a total force (F_{T}, F_{T1} . . . F_{T3}) is the magnet force (F_{M}, F_{M1} . . . F_{M3}) plus the spring force (F_{S}, F_{S1} . . . F_{S3}),
a differential of the total force (F_{T}, F_{T1} . . . F_{T3}) over an excursion (z) of the outer magnetic circuit part (6a . . . 6k) is defined as a total force gradient (dF_{T}/dz), and
the total force gradient (dF_{T}/dz) is zero at least in sections of a graph of the total force gradient (dF_{T}/dz) over the excursion (z) of the outer magnetic circuit part (6a . . . 6k) or the coil arrangement (3a, 3b) respectively.

10. The electrodynamic actuator (1a . . . 1k) as claimed in claim 1, wherein the outer magnetic circuit part (6a . . . 6k) comprises two axially outer regions (E1, E2) and a center region (G) in-between, wherein a cross section of the center region (G) is smaller than a cross section of the outer regions (E1, E2), each seen in a cross-sectional plane perpendicular to the coil axis (C).

11. The electrodynamic actuator (1a . . . 1k) as claimed in claim 1, wherein the outer magnetic circuit part (6a . . . 6k) comprises two axially outer regions (E1, E2) and a center region (G) in-between, in which the outer magnetic circuit part (6a . . . 6k) comprises an annular recess (18a . . . 18h, 20d . . . 20j) or groove on its radially inner boundary surface (H) and/or on its radially outer boundary surface (D).

12. The electrodynamic actuator (1a . . . 1k) as claimed in claim 1, wherein the outer magnetic circuit part (6a . . . 6k) comprises two axially outer regions (E1, E2) and a center region (G) in-between, in which the outer magnetic circuit part (6a . . . 6k) comprises an annular protrusion (19c . . . 19i′) or ridge on its radially inner boundary surface (H) and/or on its radially outer boundary surface (D).

13. The electrodynamic actuator (1a . . . 1k) as claimed in claim 1, wherein the coil arrangement (3a, 3b) comprises exactly two axially spaced voice coils (4a, 4b), each having an electrical conductor in the shape of loops running around a coil axis (C) in a loop section.

14. The electrodynamic actuator (1a . . . 1k) as claimed in claim 12, wherein the outer magnetic circuit part (6a . . . 6k) between the voice coils (4a, 4b) of the coil arrangement (3a, 3b) comprises:
I) a single annular protrusion (19c . . . 19i′) or ridge on a radially inner boundary surface (H) of the outer magnetic circuit part (6a . . . 6k), or
II) two distant annular protrusions (19c . . . 19i′) or ridges on a radially inner boundary surface (H) of the outer magnetic circuit part (6a . . . 6k).

15. The electrodynamic actuator (1a . . . 1k) as claimed in claim 14, wherein:
the annular protrusion (19c . . . 19i′) or ridge in case I) reaches to both voice coils (4a, 4b) and wherein the annular protrusions (19c . . . 19i′) or ridges in case II) each reach one of the voice coils (4a, 4b), or
the annular protrusion (19c . . . 19i′) or ridge in case I) is distant from both voice coils (4a, 4b) and wherein the annular protrusions (19c . . . 19i′) or ridges in case II) each are distant from both voice coils (4a, 4b).

16. The electrodynamic actuator (1a . . . 1k) as claimed in claim 1, wherein the outer magnetic circuit part (6a . . . 6k) comprises through holes (21) at an axial center position (O) or in an axial center plane (L) of the outer magnetic circuit part (6a . . . 6k).

17. The electrodynamic actuator (1a . . . 1k) as claimed in claim 1, wherein the outer magnetic circuit part (6a . . . 6k) is made of a ferro-magnetic material, and the inner magnetic circuit part (7) comprises a center magnet (8), a bottom plate (9), which is arranged adjacent to the center magnet (8) and which is made of a ferro-magnetic material, and a top plate (10), which is arranged adjacent to the center magnet (8) and opposite of the bottom plate (9) and which is made of a ferro-magnetic material.

18. The electrodynamic actuator (1a . . . 1k) as claimed in claim 1, wherein a profile contour of an airgap between the outer magnetic circuit part (6a . . . 6k) and the inner magnetic circuit part (7) in a cross sectional plane comprising the coil axis (C) is symmetric with respect to an axial center plane (N) of the outer magnetic circuit part (6a . . . 6k).

19. An output device (17), comprising a sound emanating structure (2) with a sound emanating surface(S) and a backside opposite to the sound emanating surface(S) and comprising an electromagnetic actuator (1a . . . 1k) connected to said backside, characterized in that the electromagnetic actuator (1a . . . 1k) is designed according to claim 1.

20. The output device (17) as claimed in claim 19 characterized in that the sound emanating structure (2) is embodied as a display and that the electromagnetic actuator (1a . . . 1k) is connected to the backside of the display.

21. The output device (17) as claimed in claim 19 characterized in that an average sound pressure level of the output device (17) measured in an orthogonal distance of 10 cm from the sound emanating surface(S) is at least 50 dB_SPL in a frequency range from 100 Hz to 15 kHz.

22. The output device (17) as claimed in claim 19 characterized in that the sound emanating structure (2) is embodied as a housing, which is designed for bone conduction or to contact a head of a user wearing the output device (17) respectively, and the electrodynamic actuator (1a . . . 1k) is built into the output device (17) and acoustically coupled to the housing.

23. The output device (17), as claimed in claim 22, wherein the output device (17) is embodied as a headphone or a hearing aid.

24. The electrodynamic actuator (1a . . . 1k) as claimed in claim 6, wherein
in a case i) the coil arrangement (3a, 3b) comprises a single voice coil (4), which is arranged between the first ring shaped radially outer region (J1) and the outer magnetic circuit part (6a . . . 6k), or
in a case ii) the coil arrangement (3a, 3b) comprises a first voice coil (4a) between the first ring shaped radially outer region (J1) and the outer magnetic circuit part (6a . . . 6k) and a second voice coil (4b) between the second ring shaped radially outer region (J2) and the outer magnetic circuit part (6a . . . 6k).

25. The electrodynamic actuator (1a . . . 1k) as claimed in claim 13, wherein the outer magnetic circuit part (6a . . . 6k) between the voice coils (4a, 4b) of the coil arrangement (3a, 3b) comprises:
I) a single annular protrusion (19c . . . 19i′) or ridge on a radially inner boundary surface (H) of the outer magnetic circuit part (6a . . . 6k), or
II) two distant annular protrusions (19c . . . 19i′) or ridges on a radially inner boundary surface (H) of the outer magnetic circuit part (6a . . . 6k).
